(19) United States
(12) Patent Application Publication
(10) Pub. No.: US 2009/0320987 A1
(43) Pub. Date: Dec. 31, 2009

(54) Fire resistant covering system

(76) Inventors: Michael J. Hubbard, Goshen, IN (US); Timothy J. McQuillen, Westfield, IN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/990,831

(22) PCT Filed: Aug. 21, 2006
(86) PCT No.: PCT/US2006/032617

§ 371 Date: Mar. 23, 2009

Related U.S. Application Data
(60) Provisional application No. 60/710,207, filed on Aug. 22, 2005.

(51) Int. Cl. B32B 37/12; B32B 33/00; B32B 3/06; D03D 25/00; D04H 13/00; B32B 15/04; B32B 5/00

(52) U.S. Cl. 156/71; 428/354; 428/352; 442/286; 442/394; 428/344; 428/337; 428/220

(57) ABSTRACT

A flexible covering product is provided comprising a foil layer having first and second major surfaces, a protective membrane adhered to the first major surface of the foil layer, and a pressure sensitive adhesive on at least a portion of the second major surface of the foil layer in a quantity sufficient to adhere a majority of the flexible covering product to a building structure. The adhesive is preferably covered prior to application to a building structure with a release liner. Methods of use of this flexible covering product are also described.

### PRIORITY

The present non-provisional patent Application claims benefit from U.S. Provisional Patent Application having Ser. No. 60/710,207, filed on Aug. 22, 2005, by Michael J. Hubbard, and titled FIRE RESISTANT COVERING SYSTEM, wherein the entirety of said provisional patent application is incorporated herein by reference.

### FIELD OF INVENTION

The present invention relates to fire resistant covering systems. More specifically, the present invention relates to flexible covering products comprising a foil layer.

### BACKGROUND OF THE INVENTION

For several years, fabric mesh reinforced thermoplastic membranes have been available for use as a roofing membrane. The conventional way of making such membranes is to extrude molten thermoplastic onto one side of a fabric mesh to weld the fabric mesh to one side of the thermoplastic membrane. The resulting composite is then heated and a second layer of molten thermoplastic is extruded onto the other side of the fabric mesh to cover the fabric mesh and to weld the second thermoplastic to the first thermoplastic. U.S. Pat. No. 6,054,178 to Howells describes a method of manufacturing a fabric mesh reinforced monolithic thermoplastic membrane. The open mesh fabric is drawn into the gap between two calender rollers of a membrane extruder, a molten first thermoplastic material is extruded into the throat of the gap between the first roller and the first side of the fabric mesh, while a second molten thermoplastic material is simultaneously extruded into the throat of the gap between the second roller and the second side of the fabric mesh. The composite material is then drawn through the gap between the first and second rollers to force the molten first and second thermoplastic materials into and through the open mesh of the fabric to fuse and bond the molten first and second thermoplastic materials in and about the fabric mesh to form the fabric mesh reinforced monolithic thermoplastic membrane.

Alternative material constructions have been used to provide underlayment protection to roof structures. For example, U.S. Pat. No. 5,142,837 to Simpson, et al. describes a roofing material that includes an aluminum foil top sheet that is laminated to a polyethylene film by an ionomer resin. After the sheets are bonded together they are cooled to set the resin, and an asphalt coating is applied to the exposed polyethylene sheet and covered with a release paper. The roofing material is applied over an underlayment to form a roof supported by conventional sheeting material. Another construction is a self-stick aluminum roll roofing sold by MFM Building Products Corp. of Coshocton, Ohio under the designation “Peel and Seal,” and is comprised of aluminum foil and polymer film having a rubberized adhesive backing. In both of these products, the aluminum foil is exposed as the top layer of the product.

An alternative reinforced roofing underlayment is described in U.S. Pat. No. 6,308,482 to Strait, wherein the underlayment product as described is to be positioned between a roof support structure and an overlayment in order to provide a waterproof barrier for the roof structure. The roofing underlayment includes an interwoven scrim comprising a mesh of interwoven strands of thermoplastic having a tensile strength sufficient to resist tearing when exposed to tensile loads from various directions. The interwoven scrim has a layer of waterproof material affixed to at least one side of the scrim in order to provide a weather-resistant barrier which prevents moisture and other external elements from passing through the roofing underlayment. Furthermore, the roofing underlayment may include a radiant barrier for reflecting solar energy and thereby reducing the transmission of radiant heat through the roofing underlayment. The configuration of the construction as described therein provides a reinforced roofing underlayment having an increased tensile strength to resist tearing as well as an increased resistance to deterioration from exposure to external elements.

A sheet-like sealing web for use in construction above and under ground is described in U.S. Pat. No. 4,421,807 to Clausing, et al. This sealing web comprises a resilient elastic pressure-sensitive adhesive and sealing composition enclosed between two flexible layers, the lower layer not covering the sealing composition in the vicinity of one longitudinal edge of the web and the upper layer not covering the sealing composition in the vicinity of the opposite longitudinal edge of the web, thus forming two exposed sealing strips for bonding the webs to each other in an overlapping position. Metal sheets can be used in the construction as described, wherein the metal is advantageously provided in the form of “metal-deposited plastic sheets or laminated metal/plastic sheets, e.g. an aluminum foil between two polyethylene sheets.” See column 2, lines 65-67.

Another sealing sheet assembly is described in U.S. Pat. No. 6,586,080 to Heifetz. This assembly comprises (a) an upper layer of a first substance, the upper layer being selected fluid impermeable; and (b) a lower flexible layer of a second substance, the lower flexible layer being bondable to the construction surface. The upper layer and the lower flexible layer are at least partially attached to one another, wherein a combination of the upper layer, the lower layer and the attachment or the partial attachment of the layers to one another are selected such that tensile forces resulting from constructional movements acting upon the sealing sheet result in a local detachment or relative displacement of the upper layer and the lower flexible layer. In this construction, the ability of the lower flexible layer of transmitting the forces onto the upper layer is stated to be reduced, resulting in improved service of the sealing cover as a whole. The attachment is selected such that a spread of a leakage between the layers via a tear formed in the upper layer is locally restricted. Thus, in operation of this sealing sheet assembly, the layers are designed to be easily removed from each other (i.e. the layers have low peeling forces) so that the upper layer can be readily detached from the lower layer. See column 4, lines 46-53. Additionally, when this sheet assembly is provided for roofing, the preferred embodiment has an upper sheet with a thickness of 0.8-1.3 mm, and a lower layer with a thickness of 2-5 mm.

Configurations of roofing materials having peel-and-stick functionality are described in US Patent application Nos. 2004/0157074 and 2004/0191508 to Hubbard.

### SUMMARY OF THE INVENTION

What is needed is a convenient, easy to apply construction that will provide protection to a building structure from the elements, and additionally will provide protection to a building structure from fire.

To this end, a flexible covering product is provided comprising a foil layer having first and second major surfaces, a protective membrane adhered to the first major surface of the foil layer, and a pressure sensitive adhesive on at least a portion of the second major surface of the foil layer in a quantity sufficient to adhere a majority of the flexible covering product to a building structure. The protective membrane, when provided as a multilayer construction, preferably has sufficient internal cohesive strength as to have a peel strength of at least about 15 lbs per inch in accordance with ASTM D1876. The pressure sensitive adhesive additionally has sufficient adhesive strength to the ultimate substrate to have a peel strength of at least about 0.4 lbs per inch in accordance with ASTM D-903 when bonded to test grade plywood after one hour dwell time, more preferably has a peel strength of at least about 2 lbs per inch, and most preferably at least about 4 lbs per inch. Additionally, the flexible covering product has sufficient internal cohesive strength as a laminate product that each layer of the flexible covering product, has a peel strength of at least about 2 lbs per inch and more preferably at least about 4 lbs per inch. This separate evaluation is carried out by inserting a release liner or otherwise isolating the layers during manufacture sufficiently to enable the gripper to grasp only those layers to be evaluated. The thus prepared sample is bonded to test grade plywood using a pressure sensitive adhesive having an adhesive bond strength to the plywood that is greater than the desired minimum cohesive strength of the layers to be evaluated. The thus prepared sample is evaluated in accordance with ASTM D-903. This evaluation is primarily used to evaluate the cohesion value of the protective membrane to the foil layer. For purposes of the present invention, peel strength tests are carried out on the face veneer of A-C grade, Group 1, exterior plywood.

Methods of use of this flexible covering product are also provided.

The simple construction of the present invention surprisingly provides an economical and exceptionally easy to apply covering product, but also exhibits surprising fire protection. Preferably, the flexible covering product of the present invention comprises sufficient material that exhibits fire retardancy (including in particular thickness of the foil layer) so that the product meets or exceeds the requirements of a Class C roof covering as a fully adhered covering on a combustible deck as defined in UL 790 Standard for Standard Test Methods for Fire Tests of Roof Coverings, Eighth Edition, dated Apr. 22, 2004. In other embodiments, the flexible covering product of the present invention comprises sufficient material that exhibits fire retardancy so that the product meets or exceeds the requirements of a Class B or of a Class A roof covering. Each of these roof covering class ratings are difficult to achieve in a product of this economy and ease of application, and find particular utility in specific use applications for a given cost and degree of protection desired or required for the particular application.

The flexible covering product as described herein provides a strong covering that can be walked on directly without slipping on an exposed foil surface and without degradation of the product due to shear or peel stresses. Additionally, because the flexible covering product exhibits excellent peel strength, the product is both easy to handle during application to the building structure, and exhibits excellent protection properties during ordinary wear and tear when in place on the building structure. The flexible covering product is economical because the product can be prepared from a straightforward manufacturing process, with minimal passes through production line equipment, and/or can be manufactured on production line equipment having minimal stations.

### BRIEF DESCRIPTION OF THE DRAWINGS

The accompanying drawings, which are incorporated in and constitute a part of this application, illustrate several aspects of the invention and together with a description of the embodiments serve to explain the principles of the invention. A brief description of the drawings is as follows:

FIG. 1 is an edge view of a flexible covering product of the present invention.

FIG. 2 is an edge view of an alternative embodiment of a flexible covering product of the present invention.

FIG. 3 is an edge view of an alternative embodiment of a flexible covering product of the present invention.

### DETAILED DESCRIPTION OF PRESENTLY PREFERRED EMBODIMENTS

For purposes of the present invention, the term “flexible” refers to any material that is capable of being bent, twisted, bowed, curved, etc. For example, a flexible material may be a material that is capable of being formed into a coil and capable of being unrolled from a coil to lie substantially flat. A flexible material may have the capability to be coiled in any direction. Alternatively, a flexible material may be a material that is capable of being repeatedly folded and unfolded.

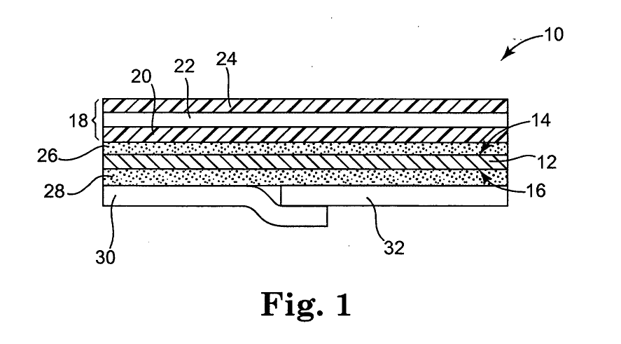

Turning now to the drawings, wherein like numbers represent like parts, FIG. 1 is an edge view of flexible covering product 10 of the present invention. In this construction, foil layer 12 has first major surface 14 and second major surface 16. Protective membrane 18 is adhered to first major surface 14 of foil layer 12.

Foil layer 12 may be prepared from any appropriate metallic material, and preferably is selected from aluminum, copper, or amalgams comprising aluminum or copper. The foil layer is provided in a thickness effective to provide the desired fire protection, which retaining flexibility of the covering product. Preferably, foil layer 12 is from about 0.012 mm to about 0.06 mm thick. In embodiments where a class C fire protection is adequate, thinner foil layer are desirable to reduce cost. and increase flexibility of the flexible covering product. In such embodiments, a preferred foil thickness is from about 0.012 mm to about 0.025 mm thick. In embodiments where a higher level of fire protection is desired, a preferred foil thickness is from about 0.025 mm to about 0.06 mm thick. In one embodiment, foil layer 12 is provided as a roll of foil to which the polymer film membrane is laminated.

Protective membrane 18 as shown is three layer laminate of a fabric layer 22 that is laminated on opposite sides with water impermeable polymeric sheets 20 and 24. Polymer film sheets 20 and 24 may be selected from thermoplastic and thermoset polymers as desired in accordance with the properties desired for the particular application of the covering product. Examples of preferred polymeric materials for use in Polymer sheets 20 and 24 include thermoplastics such as: PVC and thermoplastic polyolefins (TPO) such as polyethylene (PE), linear polyethylene (LPE), polybutenes (PB), polypropylene (PP), co-polymers of polyolefins, ethylene-propylene rubber (EPR), ethylene-propylene copolymer (EPM), ethylene propylene diene terpolymer rubber (EPDM), EPDM blended with PP or PE or copolymer, chlorinated polyethylene, chlorosulfanated polyethylene, and the like. Polypropylene based thermoplastic olefin (a thermoplastic mixture of ethylene, propylene, polypropylene and EPR manufactured by Himont North America, Inc.) has been found to be very suitable because of its thermoplastic properties, its strength and its resistance to oxidation and UV. The polymer sheets 20 and 24 may be made from a blended composite polymer having additives, such as UV screeners, UV absorbers, fire retardants, etc. to improve weatherability. In particular, polymer sheets 20 and 24 may additionally comprise UV absorbers, such as any conventional additive blended into a polymer to stabilize the adverse effects of light exposure, such as a loss of strength, degradation and decoloration. The use of a UV absorber may allow at least one layer of roofing membrane to exhibit good weathering characteristics. Examples of preferred UV absorbers additives include benzotriazole, benezophenones, hindered amine light stabilizers (HALS), non-interacting HALS (NOR-HALS), and the like. Polymer sheets 20 and 24 may additionally comprise UV screeners, such as a conventional additive blended into a polymer to reflect ultraviolet rays. Examples of preferred UV screener additives include TiO₂, carbon black, zinc oxide, and the like. Polymer sheets 20 and 24 may additionally comprise fire retardants or “FRs,” such as conventional additives blended into a polymer to reduce the flammability of a polymer by slow down the rate of combustion. Examples of preferred FRs include magnesium hydroxide, brominated FR, SbO₃, and the like.

The fabric layer 22 is preferably a non-woven or woven fabric. Examples of woven fabrics include drill, scrim, cheese-cloth, and so forth, or a knit fabric. Nonwoven fabrics preferably are nonwoven cloths made standard web forming processes, such as wet laying processes, dry laying processes (including air laying with optional carding steps) and direct laid processes (including spun-bond, melt-blown and film fibrillation processes). Nonwoven fabrics may additionally be prepared by hydroentanglement processes, wherein a web of fibers is treated with jets of high pressure water or other liquid that serves to entangle the fibers. The water or liquid jets force the fibers into orientations where the fibers individually are at various angles with respect to each other and become physically entangled. Non-limiting examples of suitable fabric materials for use according to the present invention include materials made from natural and cellulosic fibers, such as cotton, flax, jute, ramie, sisal, rayon, acetate, and lyocell and synthetic fibers such as polyesters, nylons, acrylics, polyolefins, and spandex, and the like. A suitable fabric substrate may also consist of a blend of natural and synthetic fabric materials. Particularly preferred fabrics are fiberglass fabrics. Other suitable support materials, such as wire mesh, may also be used. Fabrics or other support materials that are non-combustible or have a high resistance to heat and especially to fire are particularly preferred for use in the present invention.

Preferred fabrics for use in the present invention are provided at thicknesses of from about 0.5 to about 3 oz/yd², and more preferable from about 1 to about 2.5 oz/yd².

The fabric layer may be bonded to the polymer sheets 20 and 24 using conventional methods. Preferably, protective membrane 18 is prepared by extruding molten thermoplastic onto one or both sides of a fabric mesh either sequentially or simultaneously, such as described in U.S. Pat. No. 6,054,178 to Howells. The thickness of fabric layer 22 may be varied depending on relative durability desired in the application.

Alternatively, protective membrane 18 may be made from a two layer laminate of a polymeric film and a fabric, wherein the fabric side of the laminate is adhered to the first major surface of the foil layer. In another embodiment, protective membrane 18 may be a singly layer of polymeric material, or may be a two or more layer laminate of the same or different polymeric film materials. Protective membrane 18 can be adhered to first major surface 14 of foil layer 12 by any appropriate technique, such as by use of a pressure sensitive adhesive 26.

Adhesive 28 is provided on at least a portion of second major surface 16 of foil layer 12 in a quantity sufficient to adhere a majority (i.e. greater than about 50%) of the flexible covering product 10 to a building structure. Preferably, adhesive 28 is coextensive with second major surface 16 of foil layer 12 to provide complete adhesion of flexible covering product 10 to the intended substrate. In this preferred embodiment, the applicator can place the flexible covering product 10 on the substrate without concern regarding orientation of the product as it is unrolled on the substrate, because all of the product is coated with adhesive.

Pressure sensitive adhesive 28 is preferably a dead load shear capable adhesive. For purposes of the present invention, the term “dead load shear capable adhesive” refers to any adhesive having the property of reliably adhering the weight of a covering product, such as a roofing membrane and/or building peripheral at the upper and lower service temperatures of the covering system. A dead load shear adhesive is capable of holding 20 grams per square inch at room temperature (25 C) for 2 hours. Preferred dead load shear capable adhesives are capable of holding 50 grams per square inch at 70° C. (158° F.) for 24 hrs, and more preferably 300 grams per square inch at 70° C. (158° F.) for 24 hrs. An example of a dead load shear capable adhesive is Adco PSA-3™ manufactured by Adco Products, Inc. Adco PSA-3™ is a pressure sensitive adhesive composition comprising styrene-ethylene-butylene-styrene (SEBS), a tackifying endblock resin such as a cumarone-indene resin and a tackifying midblock resin such as a terpene resin. Other preferred dead load shear capable adhesives include: butyl-based adhesives, EPDM-based adhesives, acrylic adhesives, styrene-butadiene adhesives, polyisobutylene adhesives, ethylene vinyl acetate adhesives, and the like.

A preferred thickness of a pressure sensitive adhesive may be 0.001 to 0.5 cm. A more preferred thickness of a pressure sensitive adhesive may be 0.01 to 0.25 cm. Yet another more preferred thickness of a pressure sensitive adhesive may be 0.1 to 0.2 cm.

Release liners 30 and 32 are removably adhered to and cover adhesive 28. Release liners can be selected from any appropriate materials that can be removed from adhesive 28 at the desired time of application of the construction to a building structure. Nonlimiting examples of release liners include release liners selected from polyethylene, polypropylene, or polyester release liners. Additional nonlimiting examples of release liners include release liners selected from Kraft paper, polyethylene coated paper or polymeric materials coated with polymeric release agents selected from silicone, silicone urea, urethanes, waxes, and long chain alkyl acrylate release agents. Examples of polymeric release agent coatings are described in U.S. Pat. Nos. 3,957,724; 4,567,073; 4,313,988; 3,997,702; 4,614,667; 5,202,190; and 5,290,615; the disclosures of which are incorporated by reference herein. Examples of commercially available liners include Polyslik™ brand liners from Rexam Release of Oakbrook, Ill., USA and EXHERE™ brand liners from P.H. Glatfelter Company of Spring Grove, Pa., USA. As shown, release liners 30 and 32 are provided in two or more portions that overlap each other, much like the release liner configuration commonly used on first aid bandage strips to facilitate application of the flexible covering product 10 to the intended substrate. Thus, in application, a first portion of release liner 30 is removed from adhesive 28, and the flexible covering product 10 is applied to the intended substrate with the uncovered portion of adhesive 28. The second portion of release liner 32 is then removed from adhesive 28, and the remainder of the flexible covering product 10 can be applied to the intended substrate. Optionally, the release liner can be provided in three or more portions as desired for each of removal and placement. In another embodiment (not shown), the two portions of release liner 30 and 32 can abut each other by side by side placement or by providing a single release liner sheet that is separated into two separate sheets by, for example, a die cut.

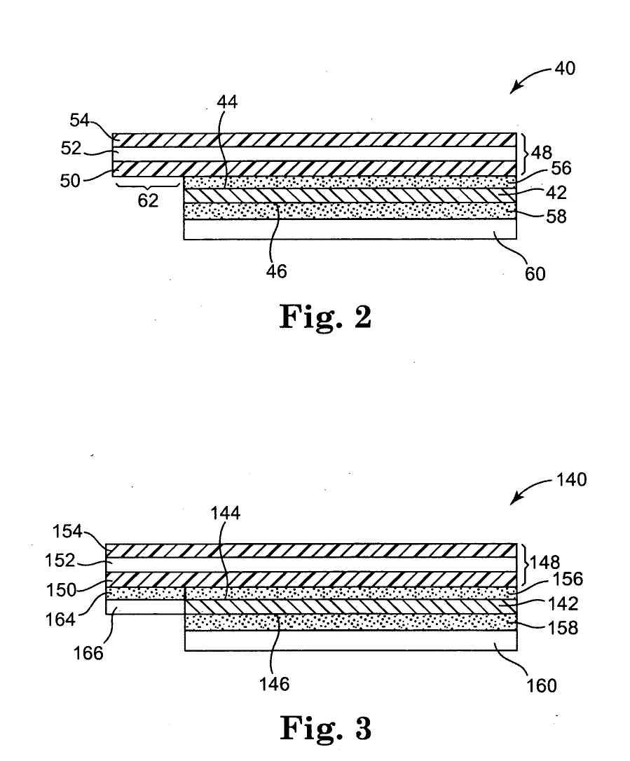

FIG. 2 is an edge view of an alternative embodiment of a flexible covering product 40 of the present invention. In this construction, foil layer 42 has first major surface 44 and second major surface 46. Protective membrane 48 is adhered to first major surface 44 of foil layer 42. Protective membrane 48 as shown is three layer laminate of a fabric layer 52 that is laminated on opposite sides water impermeable polymeric sheets 50 and 54. Protective membrane 48 can be adhered to first major surface 44 of foil layer 44 by any appropriate technique, such as by use of a pressure sensitive adhesive 56. Adhesive 58 is provided on at least a portion of second major surface 46 of foil layer 42 in a quantity sufficient to adhere a majority (i.e. greater than about 50%) of the flexible covering product 40 to a building structure. Release liner 60 is removably adhered to and covers adhesive 58.

As shown, protective membrane 48 extends beyond foil layer 42, adhesive 58 and release liner 60, providing uncoated end 62 to facilitate overlap with another section of covering material, for joining with additional covering materials with alternative joining methods such as hot welding techniques, to facilitate manipulation of edges of the covering product around additional structures on the building structure, such as pipes, air conditioning equipment and the like, or to facilitate use of conventional fastening devices, such as screws, nails, etc.

FIG. 3 is an edge view of an alternative embodiment of a flexible covering product 140 of the present invention. In this construction, foil layer 142 has first major surface 144 and second major surface 146. Protective membrane 148 is adhered to first major surface 144 of foil layer 142. Protective membrane 148 as shown is three layer laminate of a fabric layer 152 that is laminated on opposite sides by water impermeable polymeric sheets 150 and 154. Protective membrane 148 can be adhered to first major surface 144 of foil layer 144 by any appropriate technique, such as by use of a pressure sensitive adhesive 156. Adhesive 158 is provided on at least a portion of second major surface 146 of foil layer 142 in a quantity sufficient to adhere a majority (i.e. greater than about 50%) of the flexible covering product 140 to a building structure. Release liner 160 is removably adhered to and covers adhesive 158.

As shown, protective membrane 148 extends beyond foil layer 142, adhesive 158 and release liner 160, providing space for a separate adhesive 164 that is covered with release liner 166 to be adhered to protective membrane 148. Separate adhesive 164 may be the same or different from pressure sensitive adhesive 156. If separate adhesive 164 is the same as pressure sensitive adhesive 156, these two adhesives may optionally be provided in the same coating step as a continuous coating layer over protective membrane 148. Placement of this adhesive 164 facilitates overlap with and adhesive attachment to another section of covering material by adhesive 164.

One type of adhesive may be used for both sides of the foil, or different adhesives may be used for adhering different parts of the flexible covering product to each other. For example, a stronger adhesive or a more moisture resistant adhesive may be used to adhere two overlapping membranes to each other while a weaker and possibly less expensive adhesive may be used to adhere the non-overlapping portion of the roofing membrane to a roof substrate. Similarly, a hot melt adhesive may be used to adhere the protective membrane to the foil.

The final flexible covering product (excluding the release liner) preferably has a total thickness of less than about 1.5 mm. This relatively thin total thickness facilitates transportation and placement of the flexible covering product at the work site. Most preferably, none of the layers of the flexible covering product are in the form of a foam, both due to inordinate thickness and lack of strength generally observed in foam layers. It is surprising that such a thin product can provide the durability and fire protection properties as observed in the flexible covering products of the present invention.

Preferred embodiments of the present invention are provided in roll form for easy transportation to the work site, and ease of handling at the work site. Preferably, the covering product is provided to the work site in roll form dimensions are about 4 feet or more in width and about 25 feet or more in length. More preferably, the roll form dimensions are about 6 feet or more in width and about 75 feet or more in length, or about 100 feet or more in length. In another embodiment, the flexible covering embodiment is provided in rolls that are less wide to provide convenient sizes of materials for coverage of irregular shapes or for coverage of margins that are not covered in standard roll size applications. Such additional rolls are preferably provided in roll form dimensions are about 1.5 feet or more in width and about 75 feet or more in length, or alternatively in roll form dimensions that are about 3 feet or more in width and about 75 feet or more in length, or about 100 feet or more in length. In one embodiment, protective membrane 18 is provided with a slip resistant surface to facilitate walking on covering product 10 when in placed on the building structure. Alternatively separately provided walkway pads may be adhered to protective membrane 18. Such walkway pads are known in the art, and comprise a thermoplastic mat having a slip reducing surface and a pressure sensitive adhesive coated on a backside of the mat to allow the walkway pad to be adhered to protective membrane 18. Such walkway pads are sold by GenFlex™. Walkway pads may be mounted on roofs to allow access to mechanical equipment for maintenance.

The flexible covering product of the present invention can be applied to a building structure, including any building, portion of a building or other structure made of construction materials that is exposed to the elements, i.e. rain, wind, water, ice, snow, sun, etc. on a regular basis. Examples of building structures include roofs, building walls, free standing walls, sheds, chimneys, exposed pipes, culverts, above ground or underground tunnels, etc. Examples of construction materials include masonry materials such stone, brick, concrete, etc., wood (especially plywood), metal, insulation, plaster, plasterboard, etc. It will be understood that in some cases the adhesive strength of the pressure sensitive adhesive as discussed above may exceed the cohesive strength of the ultimate substrate. Thus, for example, a particularly preferred substrate for the flexible covering product of the present invention is polyisocyanurate rigid foam insulation. As noted above, preferred embodiments of the present invention utilize a pressure sensitive adhesive having an adhesion value of greater than 2 lbs per inch peel strength to plywood, which would cause destruction of the polyisocyanurate insulation if the peel strength evaluation were carried out on an polyisocyanurate insulation substrate.

In use, the flexible covering product as described herein is provided to a work site of a building structure to be covered. The release liner is removed from the flexible covering product at the work site, and the adhesive side of the flexible covering product is applied to the surface of the building structure in a manner that substantially covers the building structure surface in need of covering. The flexible covering product preferably applied to the building structure in an imbricated fashion, with adhesion between overlapping layers to provided continuous sealing and fire protection. Other than overlapping regions, the flexible product of the present invention is preferably applied to the building structure with no additional covering material is provided on top of the flexible covering product. It has surprisingly been found that the desired protection from water and weather elements, and additionally the desired level of fire protection, can be obtained by using the flexible product of the present invention without additional covering products on top of conventional building structures.

In one embodiment, the flexible covering product is applied to the vertically exposed surfaces of the building, whether the surface is a flat or pitched surface. In a particularly preferred application, no additional covering material is provided on top of the flexible covering product. Thus, the present invention provides distinct advantages in this embodiment by providing rapid and easy installation in an economical fashion.

The covering system of the present invention is preferably applied from above to a horizontal surface or from below to a curved surface. The covering system may also be used on slanted surfaces, such as slanted or peaked roofs, vertical surfaces, such as walls, chimneys, combinations of vertical and horizontal surfaces, etc., curved surfaces such as culverts, or contoured surfaces, such as terra cotta roofs, or may be applied from below to horizontal and vertical surfaces such as roof overhangs or various curved or contoured surfaces.

The parts of the flexible covering product of the present invention may be made colored or made of transparent materials to be less noticeable when applied to a building structure.

The following examples describe preferred embodiments of the invention. Other embodiments within the scope of the claims herein will be apparent to one skilled in the art from consideration of the specification or practice of the invention as disclosed herein.

### EXAMPLES

### Example 1

A flexible covering product was prepared by providing a foil layer having a thickness of about 2 mils, commercially available from Allfoil, Cleveland, Ohio A fiberglass scrim of 1.8 oz/yd weight coated on both sides with a thermoplastic polyolefin membrane (commercially available as 48 mil GenFlex TPO peel & Stick membrane from GenFlex Roofing Systems) was adhered to the first major surface of the foil layer with an 8 mil coating of PSA-3™, manufactured by Adco Products, Inc. A dead load shear capable adhesive commercially available as PSA-3™ manufactured by Adco Products, Inc. was coated on the second major surface of the foil layer at a coating thickness of 8 mils.

This flexible covering product was evaluated for fire protection in accordance with test UL 790 Standard for Standard Test Methods for Fire Tests of Roof Coverings, Eight Edition, dated Apr. 22, 2004. The product was classified as a Class B, fully adhered roof covering on a combustible deck.

The adhesion and cohesion values were evaluated in accordance with ASTM D-903 when bonded to test grade plywood after one hour dwell time, using a 2 inches per minute pull rate. It is noted that the adhesion and cohesion values normally increase with longer dwell time, and additionally the mode of failure (e.g. location of separation) may change upon longer aging. For the total composite, the adhesive layer came off of the plywood at 2.5 pounds/inch. Referring to FIG. 1, release film was placed between layers 12 and 26 in separate evaluations. The average peel strength results in both cases were 4.1 pound/inch. It is noted that there was some release of the adhesive from the foil, but only after the foil and adhesive lifted from the board.

All patents, patent documents, and publications cited herein are incorporated by reference as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A flexible covering product comprising:
a foil layer having first and second major surfaces;
a protective membrane adhered to the first major surface of the foil layer; and
a pressure sensitive adhesive on at least a portion of the second major surface of the foil layer in a quantity sufficient to adhere a majority of the flexible covering product to a building structure;
wherein the flexible covering product has sufficient internal cohesive strength as a laminate product that each layer of the flexible covering product has a peel strength between layers of at least about 2 lbs per inch; and wherein the pressure sensitive adhesive has sufficient adhesive strength that the flexible covering product has a peel strength of at least about 0.4 lbs per inch in accordance with ASTM D-903 when bonded to test grade plywood after one hour dwell time.

2. The flexible covering product of claim 1, wherein the flexible covering product has sufficient internal cohesive strength as a laminate product that each layer of the flexible covering product has a peel strength of at least about 4 lbs per inch.

3. The flexible covering product of claim 1, wherein the pressure sensitive adhesive has sufficient adhesive strength that the flexible covering product has a peel strength of at least about 2 lbs per inch in accordance with ASTM D-903 when bonded to test grade plywood after one hour dwell time.

4. The flexible covering product of claim 1, wherein the pressure sensitive adhesive has sufficient adhesive strength that the flexible covering product has a peel strength of at least about 4 lbs per inch in accordance with ASTM D-903 when bonded to test grade plywood after one hour dwell time.

5. The flexible covering product of claim 1, wherein the flexible covering product is provided in a roll form.

6. The flexible covering product of claim 1, further comprising a release liner on the pressure sensitive adhesive.

7. The flexible covering product of claim 1, wherein the protective membrane comprises a polymer film.

8. The flexible covering product of claim 7, wherein the polymer film is a thermoplastic polymer film.

9. The flexible covering product of claim 1, wherein the protective membrane is a two layer laminate of a polymeric film and a fabric, wherein the fabric side of the laminate is adhered to the first major surface of the foil layer.

10. The flexible covering product of claim 9, wherein the protective membrane has sufficient internal cohesive strength as to have a peel strength of at least about 15 lbs per inch in accordance with ASTM D1876.

11. The flexible covering product of claim 1, wherein the protective membrane is a three layer laminate of a fabric between two polymeric films.

12. The flexible covering product of claim 11, wherein the protective membrane has sufficient internal cohesive strength as to have a peel strength of at least about 15 lbs per inch in accordance with ASTM D1876.

13. The flexible covering product of claim 1, wherein the protective membrane is adhered to the first major surface of the foil layer by a pressure sensitive adhesive.

14. The flexible covering product of claim 1, wherein the foil layer comprises aluminum.

15. The flexible covering product of claim 1, wherein the foil layer comprises copper.

16. The flexible covering product of claim 1, wherein the foil layer is from about 0.025 mm to about 0.01 mm thick.

17. The flexible covering product of claim 1, wherein the pressure sensitive adhesive comprises styrene-ethylene-butylene-styrene resin.

18. The flexible covering product of claim 1, wherein the product is less than about 1.5 mm thick.

19. A method of protecting a building structure from a fire, comprising applying a flexible covering product of claim 1 to the building structure, wherein no additional covering material is provided on top of the flexible covering product.

20. A method of using the flexible covering product of claim 6, comprising:
a) providing the flexible covering product of claim 6 to a work site of a building structure to be covered,
b) removing the release liner from the flexible covering product;
c) applying the adhesive side of the flexible covering product to the surface of the building structure in a manner that substantially covers the building structure surface in need of covering, wherein no additional covering material is provided on top of the flexible covering product.
